(19) United States
(12) Patent Application Publication
(10) Pub. No.: US 2007/0178341 A1
(43) Pub. Date: Aug. 2, 2007

(54) Gas channel coating with water-uptake related volume change for influencing gas velocity

(76) Inventor: Christian Wieser, Budenheim (DE)

Correspondence Address: CARY W. BROOKS;General Motors Corporation, Legal Staff, Mail Code 482-C23-B21, P.O.Box 300, Detroit, MI, 48265-3000, US

(21) Appl. No.: 11/341,292

(22) Filed: Jan. 27, 2006

(51) Int. Cl. H01M 8/02; H01M 8/04

(52) U.S. Cl. 429/22; 429/38

(57) ABSTRACT

A fuel cell system is described having an active system for controlling local gas velocity in flow field channels by changing the gas channel cross sectional area depending on local relative humidity and state of water (i.e., vapor/liquid), thereby improving the removal of liquid water in a flow field channel. For example, a flow field channel is coated or otherwise provided with a material that swells in the presence of water vapor and/or liquid water, such as but not limited to super-absorbent materials. As the swelling continues, the channel gets narrower and the increased gas velocity leads to increased shear forces that improve the movement of the liquid water along the channel out of the cell. The water-uptake and swelling behavior is reversible and the channel will get wider as soon as the liquid is removed and/or the relative gas humidity is decreased.

### FIELD OF THE INVENTION

The present invention relates generally to fuel cell systems and more particularly to gas channel coatings for fuel cell systems.

### BACKGROUND OF THE INVENTION

Fuel cells have been used as a power source in many applications. For example, fuel cells have been proposed for use in electrical vehicular power plants to replace internal combustion engines. In PEM-type fuel cells, hydrogen is supplied to the anode of the fuel cell and oxygen is supplied as the oxidant to the cathode. PEM fuel cells include a membrane electrode assembly (MEA) comprising a thin, proton transmissive, non-electrically conductive solid polymer electrolyte membrane having the anode catalyst on one of its faces and the cathode catalyst on the opposite face. The MEA is sandwiched between a pair of electrically conductive elements, sometimes referred to as the gas diffusion media components, that: (1) serve as current collectors for the anode and cathode; (2) contain appropriate openings therein for distributing the fuel cell's gaseous reactants over the surfaces of the respective anode and cathode catalysts; (3) remove product water vapor or liquid water from electrode to flow field channels; (4) are thermally conductive for heat rejection; and (5) have mechanical strength. The term fuel cell is typically used to refer to either a single cell or a plurality of cells (e.g., a stack) depending on the context. A plurality of individual cells are commonly bundled together to form a fuel cell stack and are commonly arranged in series. Each cell within the stack comprises the MEA described earlier, and each such MEA provides its increment of voltage.

In PEM fuel cells, hydrogen (H₂) is the anode reactant (i.e., fuel) and oxygen is the cathode reactant (i.e., oxidant). The oxygen can be either a pure form (O₂), or air (a mixture of O₂ and N₂). The solid polymer electrolytes are typically made from ion exchange resins such as perfluorinated sulfonic acid. The anode/cathode typically comprises finely divided catalytic particles, which are often supported on carbon particles, and mixed with a proton conductive resin. The catalytic particles are typically costly precious metal particles. These membrane electrode assemblies are relatively expensive to manufacture and require certain conditions, including proper water management and humidification, and control of catalyst fouling constituents such as carbon monoxide (CO), for effective operation.

Examples of technology related to PEM and other related types of fuel cell systems can be found with reference to commonly-assigned U.S. Pat. No. 3,985,578 to Witherspoon et al.; U.S. Pat. No. 5,272,017 to Swathirajan et al.; U.S. Pat. No. 5,624,769 to Li et al.; U.S. Pat. No. 5,776,624 to Neutzler; U.S. Pat. No. 6,103,409 to DiPierno Bosco et al.; U.S. Pat. No. 6,277,513 to Swathirajan et al.; U.S. Pat. No. 6,350,539 to Woods, III et al.; U.S. Pat. No. 6,372,376 to Fronk et al.; U.S. Pat. No. 6,376,111 to Mathias et al.; U.S. Pat. No. 6,521,381 to Vyas et al.; U.S. Pat. No. 6,524,736 to Sompalli et al.; U.S. Pat. No. 6,528,191 to Senner; U.S. Pat. No. 6,566,004 to Fly et al.; U.S. Pat. No. 6,630,260 to Forte et al.; U.S. Pat. No. 6,663,994 to Fly et al.; U.S. Pat. No. 6,740,433 to Senner; U.S. Pat. No. 6,777,120 to Nelson et al.; U.S. Pat. No. 6,793,544 to Brady et al.; U.S. Pat. No. 6,794,068 to Rapaport et al.; U.S. Pat. No. 6,811,918 to Blunk et al.; U.S. Pat. No. 6,824,909 to Mathias et al.; U.S. Patent Application Publication Nos. 2004/0229087 to Senner et al.; 2005/0026012 to O'Hara; 2005/0026018 to O'Hara et al.; and 2005/0026523 to O'Hara et al., the entire specifications of all of which are expressly incorporated herein by reference.

Fuel cell membranes are known to have a water-uptake which is necessary to provide one primary function which is proton conductivity. The water-uptake behavior of fuel cell membranes, however, is connected with an increase of volume of the membranes if conditions become more humid or wet and with a decrease of volume if conditions become dryer. This is not desired because it applies mechanical stress on the membrane itself and adjacent fuel cell components such as the porous diffusion medium.

For example, fuel cell membranes such as those comprised of NAFION® (readily commercially available from DuPont, Wilmington, Del.) have to take up water in order to conduct ions such as protons in polymer electrolyte fuel cells. However, as previously noted, the uptake of water is combined with a humidity dependent volume change that is not desired because it applies mechanical stress on the membrane and adjacent fuel cell components, such as the porous diffusion medium.

Furthermore, mechanical properties, such as tensile strength, typically deteriorate with increased water-uptake. In polymer electrolyte membranes such as NAFION®, the increasing uptake of water strongly depends on the equilibration with water vapor or liquid water. Usually, with increasing relative humidity, water-uptake also increases. If such a membrane is brought into contact with liquid water, instead of water vapor saturated gas, the water-uptake increases dramatically (e.g., water-uptake is approximately 15 wt. % at 100% RH and 30 wt. % with liquid water at room temperature). This is generally known as Schroeder's paradox. In general, the water-uptake increases with ion exchange capacity (IEC) because the concentration of acid groups in the membrane increases. However, the mechanical properties also typically get worse.

On the other hand, flow field channels in fuel cells do not just have to distribute the gases (e.g., hydrogen and air) but also remove the product water which might be in liquid state in the channel. If the liquid water in the channel forms droplets that grow, they might form slugs that close the channel cross sectional area thereby stopping the flow. Increasing the gas velocity, and thus the shear forces on the water droplets or films, helps remove the water but requires higher stoichiometries resulting in increased compressor power and efficiency losses. Furthermore, the increased flow is distributed to all stack cells and not only to the cell that is in need of the increased flow. This is due to the fact that a conventional fuel cell is typically a passive arrangement with no active control feature.

Referring to FIGS. 1a and 1b, there is shown schematically a general description of the channel water removal and flooding problem as previously discussed. The primary components shown are flow field channel 10 (e.g., cathode flow field channel), membrane 12, catalyst layer 14 (e.g., cathode catalyst layer), and diffusion medium 16. Airflow through the flow field channel 10 is in the direction of the arrow. In this example, product water forms in the catalyst layer 14 and moves through the porous diffusion medium 16. The droplets 18 are initially quite small. However, growing water droplets 18 then form in the flow field channel 10 on the diffusion medium 16 surface. The droplets 18, if not too large, might be removed by the gas flow through the flow field channel 10. However, due to the large number of parallel channels in the flow field plate, there occurs increasing pressure drop and therefore decreasing gas flow (e.g., in volume flow and velocity) in individual channels. This phenomenon leads to reduced droplet removal thereby supporting droplet growth until the channel cross section area is closed (e.g., by a large water slug/plug 20), thus shutting off the flow field channel 10.

Accordingly, there exists a need for new and improved fuel cell systems, especially those that include systems and methods for actively managing water uptake in flow field channels so as to control local gas velocity therethrough.

### SUMMARY OF THE INVENTION

In accordance with the general teachings of the present invention, there is provided an active, self-regulating system for controlling local gas velocity in fuel cell flow fields without any effort from the fuel cell control system by simply coating the walls of fuel cell flow field channels, e.g., with a selectively reversible water absorbent swellable material. The present invention improves the movement of water in fuel cell flow field channels and thus the removal of water out of fuel cells. Thus, the decrease of fuel cell performance due to accumulation of water in flow field channels (and therefore decrease the supply of reactant gases) and occurrence of stack cells that do not get enough gas flow in a stack due to flooding (e.g., low performing cell issues, low power stability issues and/or the like) resulting in decreased stack performance or even failure can be reduced or avoided.

In accordance with a first embodiment of the present invention, a fuel cell system is provided, comprising: (1) a flow field channel operable to receive a fluid flow therethrough; (2) a diffusion medium adjacent to the flow field channel; and (3) a coating disposed on a surface of the flow field channel, wherein at least a portion of the coating is selectively and reversibly operable to absorb moisture contained in the fluid flow so as to form a swollen coating.

In accordance with a first alternative embodiment of the present invention, a fuel cell system is provided, comprising: (1) a flow field channel operable to receive a fluid flow therethrough; (2) a diffusion medium adjacent to the flow field channel; and (3) a coating disposed on a surface of the flow field channel, wherein at least a portion of the coating is selectively and reversibly operable to absorb moisture contained in the fluid flow, wherein the coating is selectively and reversibly operable to swell as the coating absorbs moisture contained in the fluid flow.

In accordance with a second alternative embodiment of the present invention, a fuel cell system is provided, comprising: (1) a flow field channel operable to receive a fluid flow therethrough; (2) a diffusion medium adjacent to the flow field channel; and (3) a coating disposed on a surface of the flow field channel, wherein at least a portion of the coating is selectively and reversibly operable to absorb moisture contained in the fluid flow, wherein the coating is selectively and reversibly operable to swell as the coating absorbs moisture contained in the fluid flow, wherein the coating is selectively and reversibly operable to cause an increase in the velocity or shear force of the fluid flow.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a schematic illustration of a flow field channel, in accordance with the prior art;

FIG. 1b is a schematic illustration of a sectional view of the flow field channel depicted in FIG. 1a, in accordance with the prior art;

FIG. 2 is a graphical illustration of several water sorption isotherms of sulfonated polyimides, in accordance with the prior art;

FIG. 3a is a schematic illustration of a sectional view of a flow field channel, exposed to relatively dry air, having a coating applied to a surface thereof, in accordance with the general teachings of the present invention;

FIG. 3b is a schematic illustration of a sectional view of a flow field channel, exposed to moderately humid air, having a coating applied to a surface thereof, in accordance with the general teachings of the present invention;

FIG. 3c is a schematic illustration of a sectional view of a flow field channel, exposed to relatively wet and/or humid air, having a coating applied to a surface thereof, in accordance with the general teachings of the present invention;

FIG. 4a is a schematic illustration of a sectional view of a flow field channel exposed to increasingly humid air, in accordance with the prior art;

FIG. 4b is a schematic illustration of a sectional view of a flow field channel, exposed to increasingly humid air, having a coating applied to a surface thereof, in accordance with one aspect of the present invention;

FIG. 4c is a graphical illustration of the gas velocity/shear forces characteristics versus channel cross-section characteristics of a flow field channel in accordance with the present invention, in accordance with one aspect of the present invention; and

FIG. 5 is a combined schematic and graphical illustration of a sectional view of a flow field channel having a coating applied to a surface thereof, wherein the coating acts as a quasi-active control mechanism for liquid removal, in accordance with one aspect of the present invention.

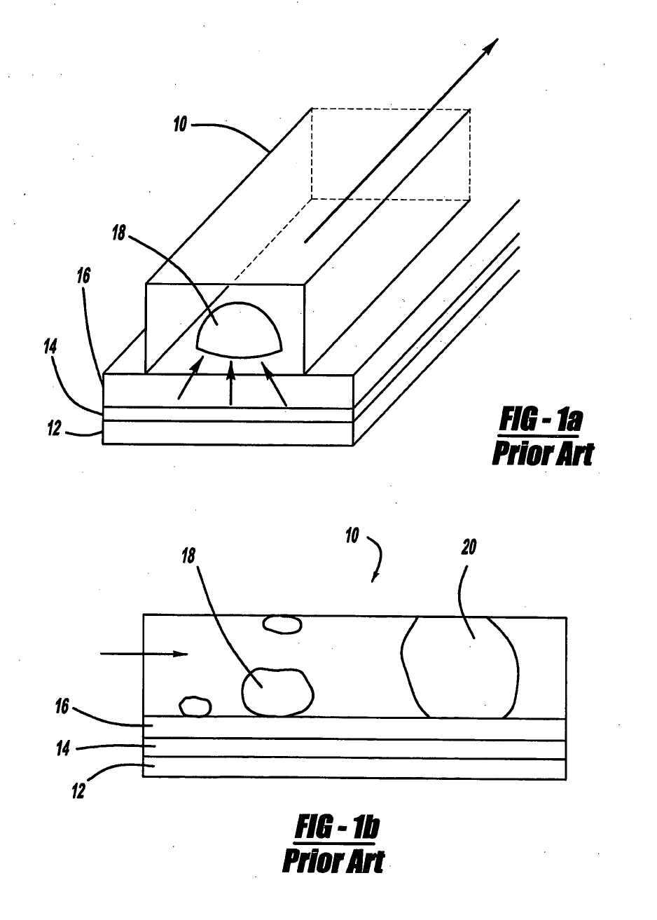

### DETAILED DESCRIPTION OF THE PREFERRED EMBODIMENTS

The following description of the preferred embodiment(s) is merely exemplary in nature and is in no way intended to limit the invention, its application, or uses.

Until now, no active feature within a fuel cell to locally control properties such as local gas velocity has been known. Thus, the present invention is intended to provide an active system of controlling local gas velocity in flow field channels by changing the gas channel cross sectional area depending on local relative humidity and state of water (i.e., vapor/liquid) thereby improving the removal of liquid water in a flow field channel.

The present invention is intended to make use of the change in volume of materials that take up water such as those used for fuel cell membranes. More specifically, the present invention consists of the application or coating of membrane material or ionomers such as but not limited to NAFION®, a perfluorinated polymer, or other super-absorbent materials (such as but not limited to hydrocarbon polymers) on the walls of flow field channels. Additionally, materials having relatively high IEC characteristics are also suitable for use in the present invention. The invention does not need the proton conduction properties of the material, but rather the property of volume increase with increasing water-uptake depending on the relative humidity and state of water in the channel. Hence, any other material rather than polymer electrolyte membranes that exhibit such behavior can fulfill the same purpose (e.g., super-absorbers such as those known for use in certain types of diapers).

If coated with a material that swells in the presence of water vapor and/or liquid water, a flow field channel will typically lose cross-sectional area and thus gas velocity for a given flow will typically increase. If the relative humidity reaches saturation and condensation occurs or liquid water penetrates the diffusion medium on the open side of the channel, the channel will get narrower and the increased gas velocity will lead to increased shear forces that improve the movement of the liquid water along the channel out of the cell. Because the water-uptake and swelling behavior is reversible, the channel will get wider as soon as the liquid is removed and/or the relative gas humidity is decreased. Because this process occurs locally in terms of in individual cells, and at certain locations in a flow field, no change of operating conditions such as increased stack flow or high stoichiometry is needed and the present invention can be considered as an active system of local flow control within a fuel cell.

By adapting the swelling behavior and coating thickness to a certain flow-field design (e.g., by varying IEC if polymer electrolytes are used) the characteristic of the velocity increase and the changed local pressure drop can be optimized. Because the coating does not need good mechanical properties, besides good adhesion on the flow-field plate, high IEC and high water-uptake properties are acceptable.

A general description of materials, such as but not limited to those materials employed as fuel cell membrane materials, that swell in the presence of water, is set forth below as an example.

Fuel cell membrane materials usually contain acid groups. These materials take up water which forms a shell around the proton due to its polar character. In order to function as a fuel cell membrane, the material has to take up enough water to dissolve the proton from the acid group and make it mobile.

This water-uptake leads to a weight and volume increase of the membrane. The water-uptake depends heavily on the density of the acid groups in the polymer (measured by the equivalent weight (EW) which is the ratio of the dry polymer mass to the mol number of acid groups) and the cross-linking of the polymer change. The more acid groups that are present (i.e., the lower the EW), the more water will be taken up. Furthermore, the more mobile the polymer chains are (i.e., the less cross-linked), the more water will be taken up.

In a conventional fuel cell, materials are preferred that have a low water-uptake since high volumetric water-uptake and, respectively, high volume change lead to mechanical membrane stress which reduces durability. Moreover, materials that need much water for high proton conductivities require high reactant humidification which, again, is not desired from a durability and system complexity perspective. However, in the case of the present invention, materials that exhibit high volumetric water-uptake and, respectively, high volume change, are suitable for use in coating the flow field channels, as previously described.

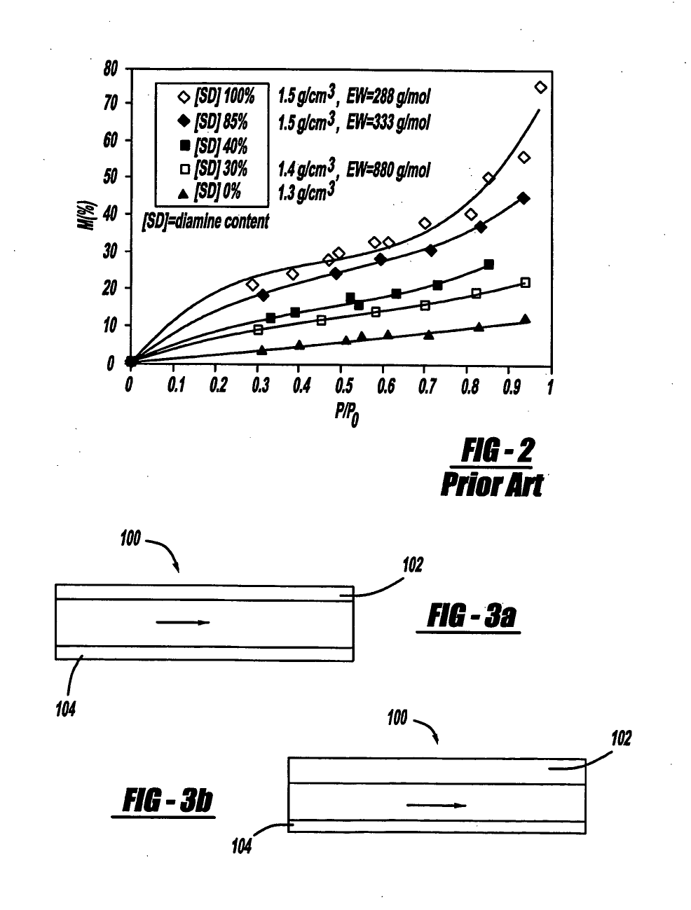

Referring to FIG. 2, there is shown a graphical illustration of several water sorption isotherms of sulfonated polyimides, in accordance with the prior art.

With respect to the y-axis, M (%) refers to the gravimetric water-uptake, i.e., mass uptake of water in relation to dry polymer (ratio of water mass vs. dry polymer mass). For example, if 10 g of polymer take up 5 g of water the gravimetric water-uptake would be 50%. With respect to the x-axis, p/p0 refers to the relative humidity as ratio of water vapor partial pressure, p, vs. saturation pressure, p0, (e.g., also called “activity”). This number is always between 0% (e.g., dry gas) and 100% (e.g., completely humidified, i.e. saturated, gas). Humidifying the gas (e.g., air) beyond 100% relative humidity and, thus, beyond saturation leads to condensation and, thus, occurrence of liquid. Because, for this proposal, the volumetric water-uptake is more relevant, one has to calculate the volumetric water-uptake (i.e., swelling) from the gravimetric water-uptake. This requires the knowledge of the density. The corresponding formula is V_{WET}/V_{DRY}=1+ρ_{DRY}/ρ_{H20}(M_{H20}/M_{DRY}), with V being the volume of wet, i.e., swollen (i.e., V_{WET}), and dry coating (i.e., V_{DRY}), respectively, ρ being the density of the dry coating (i.e., ρ_{DRY}) and water (i.e., ρ_{H20}), respectively, and M being the mass of the absorbed water (i.e., M_{H20}), and the dry coating (i.e., M_{DRY}), respectively.

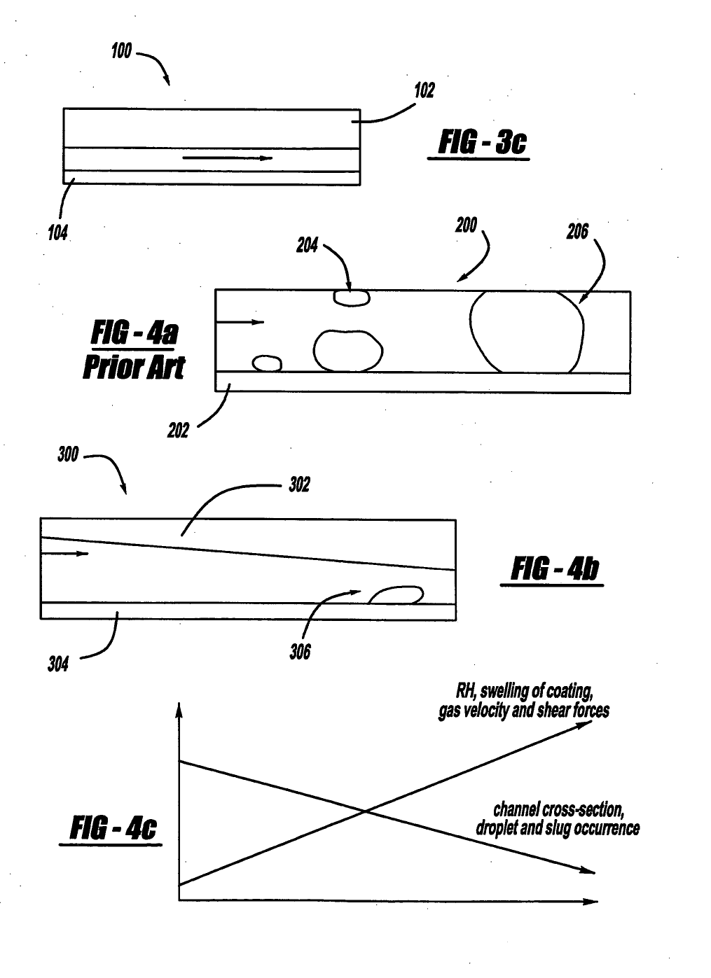

To illustrate the principles of the instant invention, reference is made to FIGS. 3a-3c, which provides a general description of the effect of the flow field channel coatings of the present invention that swell in the presence of water vapor or liquid water depending on relative humidity and condition of aggregation. In FIGS. 3a-3c, constant relative humidity (RH) and the condition of aggregation along the channel axis was assumed. Airflow through the flow field channel is in the direction of the arrow.

Referring to FIG. 3a, there is shown a schematic illustration of a sectional view of a flow field channel 100, exposed to relatively dry air, having a coating 102 applied to a surface thereof, in accordance with the general teachings of the present invention. As previously noted, the coating 102 should be comprised of a material that is selectively and reversibly water absorbent and swellable. By way of a non-limiting example, the coating 102 can be spaced and opposed from the surface of the diffusion medium 104. Additionally, in a triangular flow field channel, the coating can be applied to one or both of the adjacent walls to the wall having the diffusion medium associated therewith.

It should be appreciated that a catalyst layer (not shown) and membrane (not shown) would typically be associated with the diffusion medium 104. In this view, the channel coating 102 is unswollen when the air (i.e., fluid flow) is relatively dry or has very low RH, thus resulting in a thin coating thickness. By “fluid flow,” as that phrase is used herein, it is meant any fluid, such as but not limited to gases, liquids, and combinations thereof.

Referring to FIG. 3b, there is shown a schematic illustration of a sectional view of the flow field channel 100, exposed to moderately humid air, having the coating 102 applied to a surface thereof, in accordance with the general teachings of the present invention. In this view, the channel coating 102 starts taking up water at the presence of water vapor and increases volume, thereby increasing its thickness and, hence, reducing channel cross section. As a result, the gas velocity and shear forces increase, thereby reducing the occurrence and growth of locally increasingly appearing droplets from the diffusion medium 104.

Referring to FIG. 3c, there is shown a schematic illustration of a sectional view of the flow field channel 100, exposed to relatively wet and/or humid air, having the coating 102 applied to a surface thereof, in accordance with the general teachings of the present invention. By way of a non-limiting example, the coating 102 can be spaced and opposed from the surface of the diffusion medium 104. Additionally, in a triangular flow field channel, the coating can be applied to one or both of the adjacent walls to the wall having the diffusion medium associated therewith.

It should be appreciated that a catalyst layer (not shown) and membrane (not shown) would typically be associated with the diffusion medium 104. In this view, if RH exceeds 100%, the channel coating 102 takes up a large amount of water and swells particularly heavily, thereby reducing the risk of slug formation of the water droplets that increasingly occur from the diffusion medium 104 and condense on the channel walls.

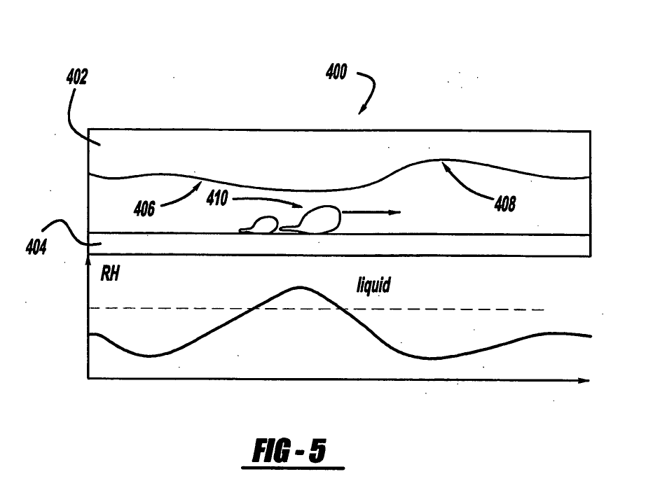

To illustrate the intended function of the present invention in situations wherein the flow field channel is subjected to increasing relative humidity conditions, reference is made to FIGS. 4a-4c. Airflow through the flow field channel is in the direction of the arrow.

Referring to FIG. 4a, there is shown a schematic illustration of a sectional view of a flow field channel 200 exposed to increasingly humid air, in accordance with the prior art. A diffusion medium 202 is shown at the bottom of the channel 200. In this view, the uncoated channel cross-sectional area and, thus, gas velocity stays constant until RH exceeds 100%. Small droplets 204 form and grow comparatively easily because gas velocity and shear forces did not increase to remove the occurring liquid, thus potentially resulting in the formation of a water plug 206.

Referring to FIG. 4b, there is shown a schematic illustration of a sectional view of a flow field channel 300, exposed to increasingly humid air, having a coating applied to a surface thereof, in accordance with one aspect of the present invention. By way of a non-limiting example, the coating 302 can be spaced and opposed from the surface of the diffusion medium 304. Additionally, in a triangular flow field channel, the coating can be applied to one or both of the adjacent walls to the wall having the diffusion medium associated therewith.

Again, it should be appreciated that a catalyst layer (not shown) and membrane (not shown) would typically be associated with the diffusion medium 304. In this view, the coated channel's cross-section decreases continuously with increasing RH thereby providing early increasing gas velocity even before liquid occurs. As soon as droplets 306 occur due to local water production, locally high RH gas velocity already is high enough to provide shear forces that help remove the liquid. In dry channel regions, air velocity is low thereby improving air humidification with product water and increasing humidification of the membrane. In humid channel regions, i.e., where the membrane already is humidified, high gas velocities remove water.

Referring to FIG. 4c, there is shown a graphical illustration of the gas velocity/shear forces characteristics versus channel cross-section characteristics of a flow field channel in accordance with the present invention, in accordance with one aspect of the present invention. In this view, the relationship between increasing RH, with the resulting swelling of the channel coating and thus increased gas velocity and shear forces with the resulting decrease in droplet and slug occurrence can be expressed.

To illustrate the intended function of the present invention in situations wherein the flow field channel coating locally acts as a quasi-active control mechanism for liquid water removal, reference is made to FIG. 5.

Referring to FIG. 5, there is shown a schematic illustration of a sectional view of a flow field channel 400 having a coating 402 applied to a surface thereof, wherein the coating 402 acts as a quasi-active control mechanism for liquid removal, in accordance with one aspect of the present invention. By way of a non-limiting example, the coating 402 can be spaced and opposed from the surface of the diffusion medium 404. Additionally, in a triangular flow field channel, the coating can be applied to one or both of the adjacent walls to the wall having the diffusion medium associated therewith. It should be appreciated that a catalyst layer (not shown) and membrane (not shown) would typically be associated with the diffusion medium 404.

In this view, the channel cross-section decreases continuously with increasing RH and vice versa as the coating material reacts directly on the local RH (see especially the graphical portion of FIG. 5). Thus, swollen portions 406 and unswollen portions 408 are formed along the length of the coating 402. Therefore, the coating 402 does not necessarily just decrease cross-section and increase flow velocity downstream, but also acts oppositely as soon as liquid (e.g., water droplets 410) vanishes or RH decreases. A RH reduction, or the disappearance of the liquid phase, might occur due to temperature gradients, current distribution, dynamic fuel cell operation (e.g., load changes, flow changes, temperature changes, and/or the like) or design features (e.g., in serpentine flow fields where the flow is redirected to the inlet region again).

As the coating 402 actively adapts to the local conditions, neither the flow field design has to be adapted to the operating conditions to avoid channel flooding (e.g., by high pressure drop designs) nor the operating conditions have to consider flooded channels or flow fields (e.g., by flow pulses during or after humid or wet events during operation). Furthermore, transients in fuel cell operation leading to wet conditions will be actively controlled locally within the fuel cell flow field. Besides the fact that each individual cell adapts itself locally on the local flow field channel conditions, each cell in the stack adapts to its own operating conditions.

Furthermore, as every cell is different due to manufacturing and assembly tolerances, the coatings of the present invention are able to compensate for these variations as it controls the cell behavior that is a result of the individual cell properties. This should increase stack durability and avoid low performing cells due to water accumulation as well as even-out RH swings due to the reduction in liquid water occurrence, thereby reducing membrane failure.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell system, comprising:
a flow field channel operable to receive a fluid flow therethrough;
a diffusion medium adjacent to the flow field channel; and
a coating disposed on a surface of the flow field channel;
wherein at least a portion of the coating is selectively and reversibly operable to absorb moisture contained in the fluid flow so as to form a swollen coating.

2. The invention according to claim 1, wherein the coating is selectively and reversibly operable to swell as the coating absorbs moisture contained in the fluid flow.

3. The invention according to claim 2, wherein the swollen coating is selectively and reversibly operable to unswell as the moisture contained in the fluid flow decreases.

4. The invention according to claim 1, wherein a first unswollen portion of the coating is selectively and reversibly operable to swell as the coating absorbs moisture contained in the fluid flow and a second swollen portion of the coating is selectively and reversibly operable to unswell as the moisture contained in the fluid flow decreases.

5. The invention according to claim 1, wherein the swollen coating is selectively and reversibly operable to cause an increase in the velocity or shear force of the fluid flow.

6. The invention according to claim 5, wherein the increase in the velocity or shear force of the fluid flow causes any liquid in the fluid flow to be removed from the flow field channel.

7. The invention according to claim 5, wherein the increase in the velocity or shear force of the fluid flow causes the swollen coating to unswell.

8. The invention according to claim 1, wherein the coating is comprised of a super-absorbent material.

9. The invention according to claim 1, wherein the coating is comprised of a material selected from the group consisting of a perfluorinated polymer, hydrocarbon polymer, and combinations thereof.

10. A fuel cell system, comprising:
a flow field channel operable to receive a fluid flow therethrough;
a diffusion medium adjacent to the flow field channel; and
a coating disposed on a surface of the flow field channel;
wherein at least a portion of the coating is selectively and reversibly operable to absorb moisture contained in the fluid flow;
wherein the coating is selectively and reversibly operable to swell as the coating absorbs moisture contained in the fluid flow.

11. The invention according to claim 10, wherein the swollen coating is selectively and reversibly operable to unswell as the moisture contained in the fluid flow decreases.

12. The invention according to claim 10, wherein a first unswollen portion of the coating is selectively and reversibly operable to swell as the coating absorbs moisture contained in the fluid flow and a second swollen portion of the coating is selectively and reversibly operable to unswell as the moisture contained in the fluid flow decreases.

13. The invention according to claim 10, wherein the swollen coating is selectively and reversibly operable to cause an increase in the velocity or shear force of the fluid flow.

14. The invention according to claim 13, wherein the increase in the velocity or shear force of the fluid flow causes any liquid in the fluid flow to be removed from the flow field channel.

15. The invention according to claim 13, wherein the increase in the velocity or shear force of the fluid flow causes the swollen coating to unswell.

16. The invention according to claim 10, wherein the coating is comprised of a super-absorbent material.

17. The invention according to claim 10, wherein the coating is comprised of a material selected from the group consisting of a perfluorinated polymer, hydrocarbon polymer, and combinations thereof.

18. A fuel cell system, comprising:
a flow field channel operable to receive a fluid flow therethrough;
a diffusion medium adjacent to the flow field channel; and
a coating disposed on a surface of the flow field channel;
wherein at least a portion of the coating is selectively and reversibly operable to absorb moisture contained in the fluid flow;
wherein the coating is selectively and reversibly operable to swell as the coating absorbs moisture contained in the fluid flow;
wherein the coating is selectively and reversibly operable to cause an increase in the velocity or shear force of the fluid flow.

19. The invention according to claim 18, wherein the swollen coating is selectively and reversibly operable to unswell as the moisture contained in the fluid flow decreases.

20. The invention according to claim 18, wherein a first unswollen portion of the coating is selectively and reversibly operable to swell as the coating absorbs moisture contained in the fluid flow and a second swollen portion of the coating is selectively and reversibly operable to unswell as the moisture contained in the fluid flow decreases.

21. The invention according to claim 18, wherein the increase in the velocity or shear force of the fluid flow causes any liquid in the fluid flow to be removed from the flow field channel.

22. The invention according to claim 18, wherein the increase in the velocity or shear force of the fluid flow causes the swollen coating to unswell.

23. The invention according to claim 18, wherein the coating is comprised of a super-absorbent material.

24. The invention according to claim 18, wherein the coating is comprised of a material selected from the group consisting of a perfluorinated polymer, hydrocarbon polymer, and combinations thereof.
